(19) United States
(12) Patent Application Publication
(10) Pub. No.: US 2014/0005887 A1
(43) Pub. Date: Jan. 2, 2014

(54) ADAPTATION TO VEHICLE ACCESSORIES

(71) Applicant: Mario TIPPELHOFER, San Mateo, CA (US)

(72) Inventor: Mario TIPPELHOFER, San Mateo, CA (US)

(73) Assignees: AUDI AG, Ingolstadt (DE); VOLKSWAGEN AG, Wolfsburg (DE)

(21) Appl. No.: 13/534,482

(22) Filed: Jun. 27, 2012

(51) Int. Cl. G06F 17/00; B60R 25/10; B60G 17/015

(52) U.S. Cl. 701/37; 701/1; 701/99

(57) ABSTRACT

Methods, apparatuses and vehicle accessories are provided. A storage unit associated with the accessory may be queried to obtain information about the accessory, and a vehicle function may be modified based on the information.

### FIELD OF THE INVENTION

The present invention relates to methods and apparatuses related to the adaptation of a vehicle to the presence of vehicle accessories, e.g. peripheral vehicle accessories like a trailer or a bike rack.

### BACKGROUND

Vehicles may be equipped with a plurality of different vehicle accessories, in particular peripheral vehicle accessories, i.e. vehicle accessories coupled with the vehicle like a car at an outside thereof. E.g., a bike rack or similar transportation device may be attached to the back of the vehicle, to a trailer hitch or to a vehicle roof. Also, roof boxes may be mounted on the vehicle roof. In other cases, a trailer may be attached to a trailer hitch of the vehicle.

Such peripheral accessories may change the behaviour of the vehicle in various instances. E.g. bicycle racks or roof boxes increase the overall outer dimension of the vehicle, which may lead to problems when the driver drives the vehicle into a garage or under a low bridge, which potentially may lead to damage. Also, vehicle properties like acceleration behaviour, deceleration (braking) behaviour or fuel consumption may be changed. Functions like a parking assist function may cause trouble as the wrong dimensions of the vehicle are used for calculation, and/or sensors mounted at the rear of the vehicle may be at least partially malfunctioning, e.g. due to a bicycle rack mounted to the back. In other situations, when the trunk lid of the vehicle is opened, e.g. by manual or automatic actuation via a remote key, when a bike rack is attached, the lid will hit the rack, which may cause damage. On the other hand, roof racks or similar transportation means attached to the top of the vehicle may cause damage to a sun roof and to convertible tops when opening them.

Therefore, a need exists for means to help e.g. a driver of a vehicle to cope with such changes to the vehicle behaviour caused by vehicle accessories.

### SUMMARY

According to an aspect, a method is provided, comprising:

reading out information stored in a storage attached to a vehicle accessory, and

modifying a vehicle function based on the read-out information.

In other words, according to this aspect, information is stored in a storage attached to a vehicle accessory. By reading out the storage, vehicle functions may be modified appropriately so that the presence of the accessories may be taken into account or, in other words, the vehicle may be adapted to the presence of the accessories.

In some embodiments, the reading out may comprise transmitting a request and receiving the read-out information, e.g. in a wireless manner.

The information may comprise one or more of a type of the accessory, one or more dimensions of the accessory, a weight of the accessory and the manufacturer of the accessory.

Modifying the vehicle function may be e.g. modify the output of a display or an audio output to inform a driver of the vehicle of the presence of the accessory, but may alternatively or additionally also comprise modifying a parking assistant function and/or modifying a drive control function, e.g. to adapt the vehicle to increased fuel consumption.

According to another embodiment, a control apparatus for a vehicle is provided, comprising:

a transceiver configured to read out a storage attached to a vehicle accessory; and

an evaluation unit configured to modify a vehicle function based on the read-out information.

The transceiver may in particular be a wireless transceiver. The information and/or the modification of the vehicle functions may be as already described for the first aspect.

According to a third aspect, a vehicle accessory comprising a storage attached thereto is provided, the storage storing information characterizing the vehicle accessory. In some embodiment, the storage may comprise a RFID tag which is readable in a wireless manner.

The above aspects and embodiments may be combined with each other unless specifically noted otherwise to form other embodiments and aspects.

### BRIEF DESCRIPTION OF THE SEVERAL VIEWS OF THE DRAWINGS

### Brief Description of the Drawings

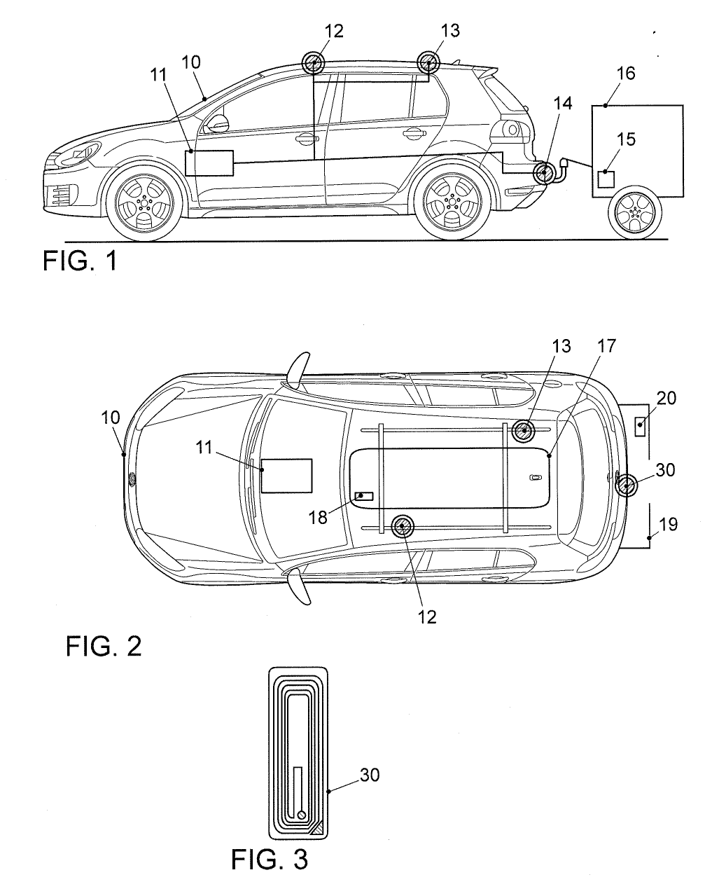

FIG. 1 is a schematic representation of a vehicle equipped with a control apparatus according to an embodiment.

FIG. 2 is a top view of the vehicle of FIG. 1 with different accessories attached.

FIG. 3 shows an example of an RFID chip usable in some embodiments.

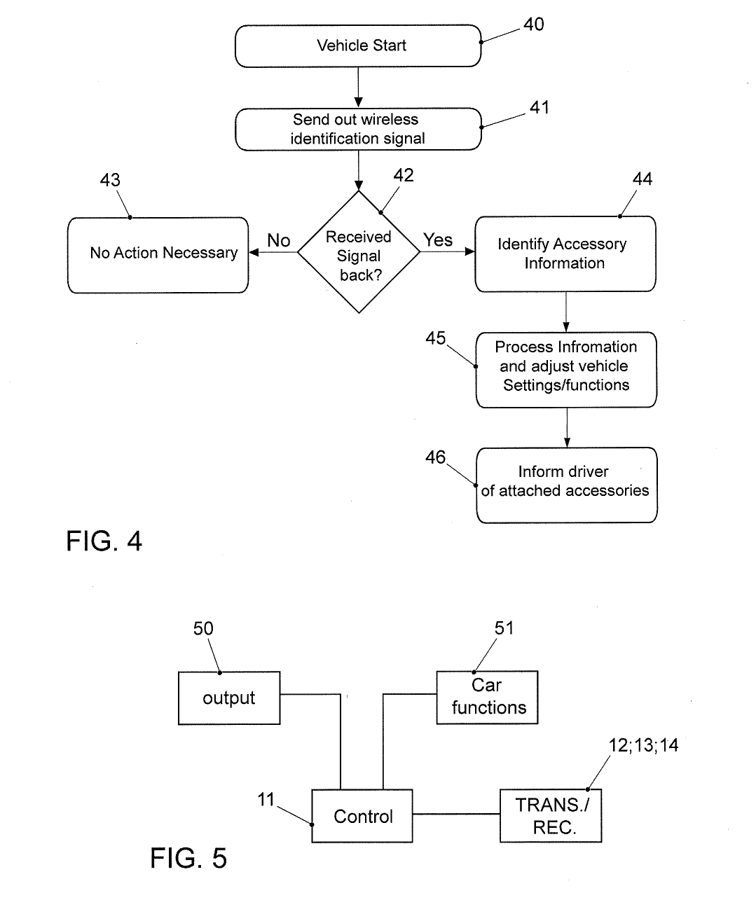

FIG. 4 shows a flowchart of a method according to an embodiment.

FIG. 5 schematically illustrates a control apparatus according to an embodiment.

### DETAILED DESCRIPTION

Embodiments of the invention now will be described in detail with reference to the attached drawings. It should be noted that the drawings and the following description are given only for the purpose of illustration and are not to be construed as limiting the scope of the present application.

Features of different embodiments described in the following may be combined with each other unless specifically noted otherwise to form additional embodiments. On the other hand, describing an embodiment with a plurality of features is not to be construed as indicating that all those features are necessary for practicing the present invention, as other embodiments may comprise less features and/or alternative features.

In the following, adaptation of a vehicle in the presence of vehicle accessories will be discussed. Adaptation in this respect refers to any action performed which facilitates a handling of the vehicle with the accessories attached for a driver of the vehicle. This facilitating may e.g. simply consist in outputting warning and/or information messages to a driver but may also relate to measures influencing the behaviour of the vehicle or systems incorporated therein.

The vehicle may be any kind of vehicle, in particular a land based vehicle like a car or a truck. Vehicles accessory relates to any item which may be attached to the vehicle e.g. to provide additional features or possibilities. A peripheral accessory relates to an accessory which is attachable to the outside of the vehicle.

Turning now to the figures, in FIG. 1 a side view of a vehicle 10 equipped with an apparatus according to an embodiment is shown. In the example of FIG. 1, the apparatus comprises a control unit 11 and transceivers 12, 13 and 14. Transceivers 12 and 13, as also can be seen in the top view of FIG. 2, are mounted near a roof railing of vehicle 10, while transceiver 14 is mounted at the rear of vehicle 10. Control unit 11 is configured to control transceivers 12, 13 and 14 to read out storage units in accessories attached to vehicle 10. Control unit 11 then processes the readout information and modifies vehicle functions of vehicle 10, as will be explained in greater detail further below.

As an example for an accessory, in FIG. 1 a trailer 16 attached to a trailer hitch of vehicle 10 is shown. Trailer 16 comprises a storage unit 15 attached thereto, which e.g. may be read out by transceiver 14 in a wireless manner. In FIG. 2, which represents a top view of vehicle 10 with different accessories attached, a roof box 17 is mounted to the roof railing of vehicle 10. Roof box 17 has a storage unit 18 attached thereto, which may be read out e.g. by transceiver 12. Furthermore, vehicle 10 in FIG. 2 has a bicycle rack 19 attached to the rear, a storage unit 20 being attached to bicycle rack 19.

It should be noted that the accessories shown in FIGS. 1 and 2 serve merely as an example, and other accessories such as a bike rack mounted to the roof top, e.g. to the roof railing, or a ski rack mounted to the roof are also possible. Also, the number of three transceivers 12, 13 and 14 servers merely as an example, and any number of transceivers may be used. In some cases, the number of transceivers used may depend on the range of the transceiver. If e.g. in case of a specific implementation a single transceiver is sufficient to communicate with all possible accessories which are to be taken into account by the corresponding apparatus, a single transceiver may be sufficient. The placement of the transceivers, as shown in FIGS. 1 and 2, may be made nearby the locations where typical peripheral accessories are mounted.

Storage units 15, 18 and 20 in some embodiments may be RFID chips (radio frequency identification) which are passive circuits and therefore do not require a battery, but respond in a passive manner based on a signal received from a transceiver, e.g. one of transceivers 12, 13 and 14. However, in other embodiments active storage units may be used. An example of a printed RFID chip 30 usable in embodiments of the present invention is shown in FIG. 3.

In FIG. 4, a flowchart illustrating a method according to an embodiment is shown. While in FIG. 4 the method is shown as a series of acts or events, it should be noted that the order in which the various actions and events are described is not to be construed as limiting the scope of the invention. In other embodiments, the order of at least some of the acts or events may be changed, some acts of events may be omitted, and/or some acts or events may be executed concurrently with each other or concurrently with further acts or events not shown in FIG. 4.

The method of FIG. 4 may e.g. be implemented in the apparatus shown in FIGS. 1 and 2, e.g. by configuring, e.g. programming, control unit 1 accordingly using software, hardware, firmware or any combination thereof.

At 40, a vehicle, e.g. vehicle 10 of FIGS. 1 and 2, is started. This may be done in any conventional manner, e.g. by turning an ignition key or by pressing a start button. At 41, a wireless identification signal querying the presence of storage units assigned to accessories is sent out. In some embodiments, the wireless identification signal may be a signal adapted to read out RFID chips.

At 42, it is checked if a signal is received back from such storage unit. If no, at 43 it is determined that no action is necessary as no accessory is present. If a signal is received back, at 44, the accessory information contained in the received signal, i.e. the information stored in the storage unit, is identified. In some embodiments, this information comprises one or more of physical dimensions of the accessory, a weight of the accessory, a drag factor of the accessory, i.e. information how the accessory influences air resistance of the vehicle, a type of accessory (bike rack, roof box, trailer . . . ) and/or a manufacturer of the accessory. At 45, the information is processed and vehicle setting and/or functions may be adjusted based on the information. E.g. a motor management may be adjusted based on the drag factor to take increased fuel consumption into account and to optimise fuel consumption in view of the presence of the accessory, a parking assist system or similar systems may be updated to take additional dimensions into account, shock absorbers (dampers) may be adjusted to take additional weight into account etc. Additionally or alternatively to the adjusting of vehicle setting or functions at 46, the driver may be informed of the attached accessory. E.g. a warning message may be displayed if an accessory increasing the height of the vehicle is mounted to the roof so that the driver is easily aware of the accessory and can take its presence into account when driving.

It should be noted that in some embodiments the method shown in FIG. 4 may be not only performed at start of the vehicle, but also in regular intervals e.g. also when the vehicle is parked. In this way, e.g. a theft of an accessory may be detected if suddenly an accessory is not identified as being present any longer. In this case, at 46, a driver may be informed accordingly, e.g. by sounding an alarm.

Warnings and other information at 46 may also be output depending on a driving situation. E.g. many vehicles are equipped with distance warnings and similar devices warning a driver of potentially dangerous situations. Such warnings, when an accessory is identified, can take additional dimensions of the accessory into account in some embodiments.

In some embodiments, the methods and apparatuses of the invention may also interact with facilities such as an automatic garage door opener, such when the garage door is opened and an accessory was detected on the vehicle roof, a warning may be given to the driver.

In FIG. 5 the interaction of an apparatus according to an embodiment as e.g. depicted in FIGS. 1 and 2 with car functions is shown. In FIG. 5, control unit 11 and transceivers 12, 13 and 14 are schematically shown. Control unit 11 interacts with car functions 51, e.g. drive assistance functions, motor management functions and also with car functions involving an output 50 such as a display or loudspeakers to perform one or more of the various functions described above.

In this way, car functions such as engine settings, motor management, drive assist may be adjusted to the presence of accessories, and via output 50 corresponding information and warnings may be output to a driver.

When e.g. in some embodiments the accessory is a trailer, having information about size, weight etc. of the trailer available helps to adjust certain engine settings for improved fuel economy. Similar considerations hold true for larger accessories such as roof top boxes, canoes or bike racks which impact the wind drag of the vehicle which in effect increases the fuel consumption. Such an adjustment of engine settings etc. may have particular usefulness in case of electric vehicles where driving range is a critical issue.

It should be noted that while embodiments have been described as communicating in a wireless manner with storage units associated with accessory in other embodiments, the communication may be wire-based.

As already mentioned, the above described embodiments serve only as non-limiting examples, and variations, modifications and alterations are possible without departing from the scope of the application.

What is claimed is:

1. A method comprising:
transmitting a request for information from at least one storage unit assigned to vehicle accessories,
receiving information from said at least one storage unit, and
modifying vehicle functions based on said information.

2. The method of claim 1, further comprising determining that no vehicle accessory is present if no information is received.

3. The method of claim 1, wherein said at least one storage unit comprises an RFID chip.

4. The method of claim 1, wherein said modifying vehicle functions comprise outputting information to a driver of the vehicle.

5. The method of claim 4, wherein said outputting of information is performed depending on a drive situation of the vehicle.

6. The method of claim 1, wherein said modifying vehicle functions comprise modifying one or more functions selected from the group consisting of an engine management, a damper setting, a drive assistance, and a parking assistance.

7. The method of claim 1, wherein said information comprises at least one information of the group consisting of a physical dimension of the accessory, a weight of the accessory, a drag factor of the accessory, a manufacturer of the accessory and a type of the accessory.

8. The method of claim 1, wherein modifying vehicle functions comprises outputting a theft warning if previously received information is not received any longer.

9. An apparatus for a vehicle, comprising:
a transceiver configured to query information from a storage unit associated with a vehicle, and
a control unit configured to modify at least one vehicle function based on said information.

10. The method of claim 9, wherein said vehicle function comprises at least one vehicle function selected from the group consisting of a damper, an engine management, a drive assistance and a parking assistance.

11. The apparatus of claim 9, wherein said transceiver is configured to read out RFID chips.

12. The apparatus of claim 9, wherein said control unit is configured to control an output of the vehicle to output information to a driver of the vehicle based on said information.

13. A vehicle accessory, comprising a storage unit storing information about the accessory, the storage unit being readable by a transceiver.

14. The vehicle accessory of claim 13, wherein said information comprises one or more information selected from the group consisting of a physical dimension of the accessory, a weight of the accessory, a drag factor of the accessory and a manufacturer of the accessory and a type of the accessory.

15. The accessory of claim 13, wherein said storage unit comprises an RFID chip.
